(19) United States
(12) Patent Application Publication
(10) Pub. No.: US 2015/0083058 A1
(43) Pub. Date: Mar. 26, 2015

(54) CYLINDER HEAD

(71) Applicant: GE Jenbacher GmbH & Co OG, Jenbach (AT)

(72) Inventor: Florian BECKER, Maurach a.A. (AT)

(21) Appl. No.: 14/486,013

(22) Filed: Sep. 15, 2014

(30) Foreign Application Priority Data
Sep. 25, 2013 (AT) 738/2013

(51) Int. Cl. F02F 1/40; F02F 1/24

(52) U.S. Cl. CPC F02F 1/40; F02F 1/242
USPC 123/41.29; 123/41.79

(57) ABSTRACT

A cylinder head having a thread for an ignition device, in particular a spark plug, and a cooling circuit having at least one cooling cavity, wherein the cylinder head can be cooled in operation by conveying cooling medium through the cooling circuit, wherein provided in the cooling circuit is a further cooling cavity having an inside wall and an inlet opening disposed substantially in opposite relationship to the inside wall, and a cooling medium flow entering through the inlet opening can be so deflected by the inside wall that the cooling medium flow passes at least partially around the thread.

The present invention concerns a cylinder head having the features of the classifying portion of claim 1 and an internal combustion engine having such a cylinder head.

As the spark plug thread of a cylinder head is relatively close to the region in which some of the highest temperatures occur in the internal combustion engine due to ignition the spark plug thread is exposed to relatively severe thermal loadings. As moreover in comparison with the surrounding structures it is in part of a quite delicate nature there can be the need for cooling of the spark plug thread. That applies in particular to gas engines with a prechamber system in which a highly ignitable fuel-air mixture is burnt to ignite a very lean fuel-air mixture in a main combustion chamber.

There are various specifications in the state of the art, which deal with that problem. Mention should firstly be made of DE 699 26 065 T2. By virtue of the enlargement of a large cooling cavity paired with a specific configuration of the enlargement the attempt is made to bring cooling medium close to the spark plug thread. A disadvantage in that respect is that a directed flow near the spark plug thread cannot be formed. The cooling effect for the spark plug thread is therefore limited in that specification as the discharge of heated cooling medium takes place only by convection and similar processes. A similar consideration applies to EP 1 128 034 A2.

A further approach to cooling the spark plug thread originates from WO 2011/041805 A1. That proposes placing a separate cooling circuit provided only for cooling the spark plug and in particular the spark plug thread. By virtue thereof it is even possible to use a cooling medium—for example oil—which is better suited to the specific purposes of cooling the spark plug thread. This however is a highly complicated and expensive solution as on the one hand it requires a pump separate from the remaining cooling circuit of the cylinder head and secondly because the additional cooling circuit must be placed almost completely in the spark plug sleeve. If therefore a directed flow in the proximity of the spark plug thread is to be produced that entails a considerable level of manufacturing complication and expenditure for placement of the cooling passages in the spark plug sleeve.

The object of the invention is to provide a cylinder head and an internal combustion engine having such a cylinder head, which allow effective cooling of the spark plug thread at a moderate level of manufacturing complication and expenditure.

That object is attained by a cylinder head having the features of claim 1 and by an internal combustion engine having such a cylinder head.

That is effected in that provided in the cooling circuit is a further cooling cavity having an inside wall and an inlet opening disposed substantially in opposite relationship to the inside wall, wherein a cooling medium flow entering through the inlet opening can be so deflected by the inside wall that the cooling medium flow passes at least partially around the thread.

In particular a part of the invention provides that the further cooling cavity is part of the cooling circuit which is present in any case for cooling the cylinder head, that is to say cooling is substantially afforded in the usual mode of operation by the cooling circuit of the cylinder head.

A further aspect of the invention provides that there is a further cooling cavity which surrounds the thread and in which a directed positive flow is induced.

Further advantageous embodiments of the invention are recited in the appendant claims.

To permit cooling of the thread which is as symmetrical and regular as possible it can be provided that the cooling medium flow can be divided by the inside wall into two flow portions which pass in mutually opposite directions at least in part around the thread. The effect of symmetrical cooling can be enhanced by the cooling medium flow being so deflectable by an outside wall of the further cooling cavity that it passes completely around the thread.

Cooling of the thread that is as symmetrical as possible can be advantageous as thermal stresses resulting from excessive temperature differences can lead to cracks and fractures.

Simple discharge of the cooling medium can be achieved if the flow portions can be so deflected by the outside wall that they are combined to give an issuing cooling medium flow or there is provided an outlet opening for the outlet of the cooling medium flow out of the further cooling cavity.

For simple manufacture it can be advantageous if the geometry of the inside wall and/or of the outside wall substantially corresponds to the peripheral surface of a cylinder.

The effect already described of symmetrical cooling of the thread can be optimized by the further cooling cavity being of a substantially annular configuration.

Further adaptation of the further cooling cavity to the shape of the thread can be achieved by the further cooling cavity being of a substantially polygonal, preferably substantially rectangular, cross-section.

For particularly simple manufacture it can be provided that the further cooling cavity is formed by a groove in an insert together with a spark plug sleeve as it allows relatively simple manufacture of a curved, in particular annular, passage.

The fact that provided in the spark plug sleeve for incorporating the further cooling cavity into the cooling circuit is at least one bore connected to the inlet opening and/or the outlet opening means that it is possible to avoid the spark plug sleeve being of a complex or expensive configuration.

For particularly effective cooling of the thread it can be provided that a spacing of the further cooling cavity relative to the thread is less than 40 mm, preferably less than 20 mm and particularly preferably less than 10 mm.

Further advantages and details of the invention will be apparent from the Figures and the related specific description. In the Figures:

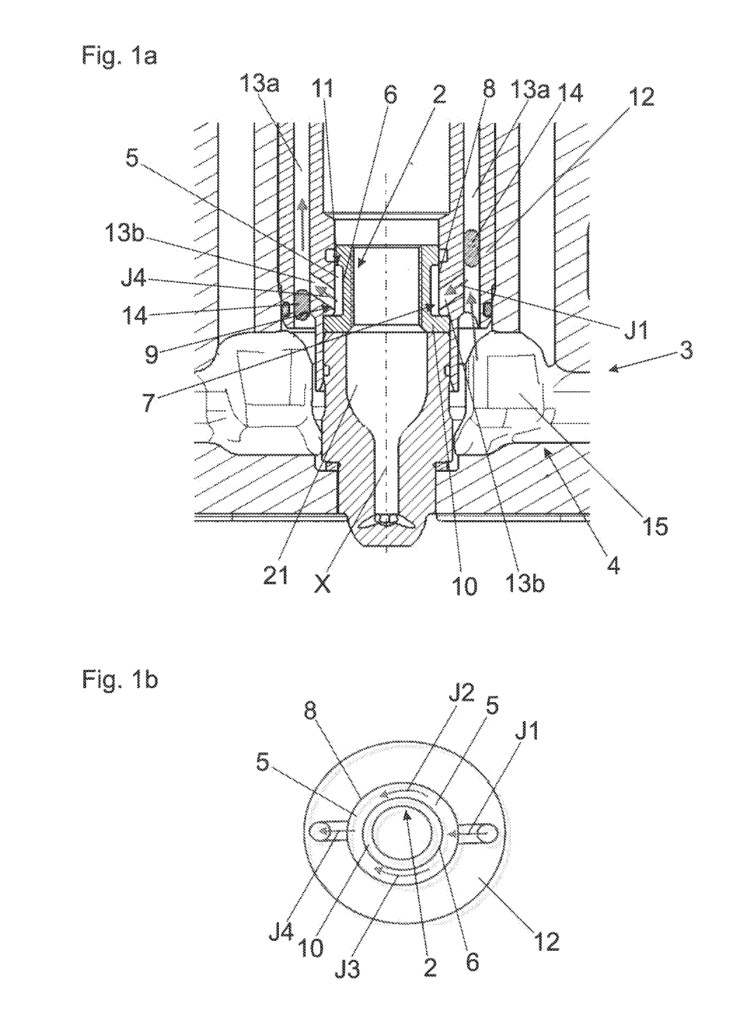

FIG. 1a shows a sectional view through a cylinder head according to the invention in a plane containing a cylinder axis,

FIG. 1b shows a diagrammatic sectional view perpendicularly to the cylinder axis,

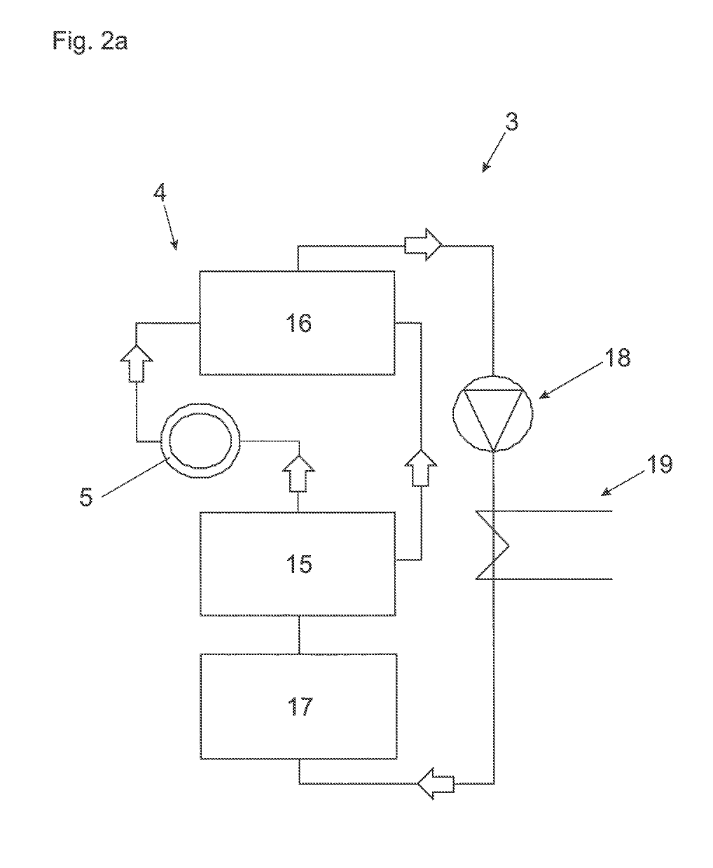

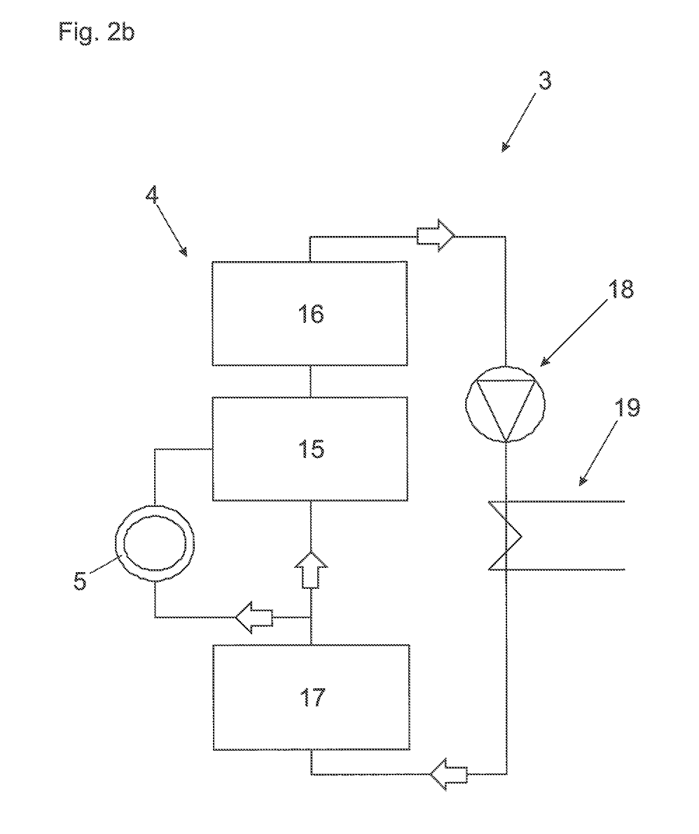

FIG. 2a shows a diagrammatic arrangement of the further cooling cavity in the cooling circuit, and

FIG. 2b shows a further embodiment of an arrangement of the further cooling cavity in the cooling circuit.

FIG. 1a shows the further cooling cavity 5. It is formed by an insert 10 together with the spark plug sleeve 12. In this embodiment the insert 10 is pressed between the spark plug sleeve 12 and the component which contains the prechamber 21.

The further cooling cavity has an inside wall 6 formed in a groove 11 in the insert 10 and an outside wall 8 formed by the spark plug sleeve 2. In this case the at least one cooling cavity 4 is provided by a first cooling cavity 15 and a second cooling cavity 16, the second cooling cavity 16 being diagrammatically shown in FIGS. 2a and 2b. The at least one cooling cavity 4 is connected to the further cooling cavity 5 through four bores 13 in the spark plug sleeve 12. They are so placed that they are easy to produce in the dismantled condition of the spark plug sleeve 12.

Firstly there are two longitudinal bores 13a which extend parallel to a cylinder axis X and which respectively form a communication between the first cooling cavity 15 and the second cooling cavity 16. Two inclined bores 13b provide the inlet opening 7 and the outlet opening 9 and connect them to the above-described longitudinal bores 13a. The angular positioning (with respect to the cylinder axis X) of the inclined bores 13b permits production thereof by a procedure whereby, with the insert 10 dismantled, the lower opening of the spark plug sleeve 12 is accessible to borers. Finally the communication between the longitudinal bore 13a and the first cooling cavity 15 or the second cooling cavity 16 respectively is interrupted by means of plugs 14.

As in operation there is a pressure difference between the first cooling cavity 15 and the second cooling cavity 16 a cooling medium flow J1 passing into the further cooling cavity 9 and an issuing cooling medium flow J4 are formed.

In this embodiment water is used as the cooling medium. That however is not essential to the invention.

The flow situation is better illustrated by reference to FIG. 1b. It diagrammatically shows the further cooling cavity 5 formed by the insert 10 and the spark plug sleeve 12. The thread 2 is also diagrammatically indicated.

The incoming cooling medium flow J1 is divided by the inside wall 6 into the two flow portions J2 and J3 which pass in mutually opposite directions through the further cooling cavity 5. The outside wall 8 holds the flow portions J2 and J3 on a substantially circular path and combines them to give an issuing cooling medium flow J4.

FIG. 2a diagrammatically shows the entire cooling circuit 3 for the embodiment of FIGS. 1a and 1b. The cooling medium—in this case water—is conveyed through a cooling radiator 19 by means of a pump 18. It firstly passes into the main cooling cavity 17 and then into the first cooling cavity 15. From there the cooling medium flows on two paths connected in parallel to the second cooling cavity 16, in which respect on the one hand there is provided a direct communication and on the other hand there is a communication which passes through the further cooling cavity 5. From the second cooling cavity 16 the cooling medium flows back to the pump 18.

The embodiment shown in FIG. 2b differs from that shown in FIG. 2a in that the cooling medium is divided up after the main cooling cavity 17. One flow portion leads directly to the first cooling cavity 15 while a second flow portion passes through the further cooling cavity 5.

The present invention is not limited to the embodiments by way of example illustrated here. For example it is possible to also use the present concept in cylinder heads without prechambers.

1. A cylinder head having a thread for an ignition device, in particular a spark plug, and a cooling circuit having at least one cooling cavity, wherein the cylinder head can be cooled in operation by conveying cooling medium through the cooling circuit, wherein provided in the cooling circuit is a further cooling cavity having an inside wall and an inlet opening disposed substantially in opposite relationship to the inside wall, wherein a cooling medium flow entering through the inlet opening can be so deflected by the inside wall that the cooling medium flow passes at least partially around the thread.

2. A cylinder head as set forth in claim 1, wherein the cooling medium flow can be divided by the inside wall into two flow portions which pass in mutually opposite directions at least in part around the thread.

3. A cylinder head as set forth in claim 1, wherein the cooling medium flow can be so deflected by an outside wall of the further cooling cavity that it passes completely around the thread.

4. A cylinder head as set forth in claim 2, wherein the flow portions can be so deflected by the outside wall that they are combined to give an issuing cooling medium flow.

5. A cylinder head as set forth in claim 1, wherein there is provided an outlet opening for the outlet of the cooling medium flow out of the further cooling cavity.

6. A cylinder head as set forth in claim 1, wherein the geometry of the inside wall and/or of the outside wall substantially corresponds to the peripheral surface of a cylinder.

7. A cylinder head as set forth in claim 1, wherein the further cooling cavity is of a substantially annular configuration.

8. A cylinder head as set forth in claim 1, wherein the further cooling cavity is of a substantially polygonal, preferably substantially rectangular, cross-section.

9. A cylinder head as set forth in claim 1, wherein the further cooling cavity is formed by a groove in an insert together with a spark plug sleeve.

10. A cylinder head as set forth in claim 1, wherein provided in the spark plug sleeve for incorporating the further cooling cavity into the cooling circuit is at least one bore connected to the inlet opening and/or the outlet opening.

11. A cylinder head as set forth in claim 1, wherein a spacing of the further cooling cavity relative to the thread is less than 40 mm, preferably less than 20 mm and particularly preferably less than 10 mm.

12. A cylinder head as set forth in claim 1, wherein the cylinder head has a first cooling cavity and a second cooling cavity, wherein the inlet opening is connected to the first cooling cavity and the outlet opening (9) is connected to the second cooling cavity.

13. An internal combustion engine having a cylinder head as set forth in claim 1.

14. An internal combustion engine as set forth in claim 13, wherein the internal combustion engine has a main cooling cavity for cooling the engine block, wherein the inlet opening is connected to the main cooling cavity and the outlet opening is connected to the at least one cooling cavity.
